(19) United States
(12) Patent Application Publication
(10) Pub. No.: US 2022/0304057 A1
(43) Pub. Date: Sep. 22, 2022

(54) METHODS, TERMINAL DEVICE AND NETWORK NODE FOR UPLINK TRANSMISSION

(71) Applicant: Telefonaktiebolaget LM Ericsson (publ), Stockholm (SE)

(72) Inventors: Jinhua LIU, Beijing (CN); Min WANG, Luleå (SE)

(73) Assignee: Telefonaktiebolaget LM Ericsson (publ), Stockholm (SE)

(21) Appl. No.: 17/597,031

(22) PCT Filed: Apr. 30, 2020
(86) PCT No.: PCT/CN2020/088387

§ 371 Date: Dec. 22, 2021

(30) Foreign Application Priority Data
Jun. 27, 2019 (CN) PCT/CN2019/093162

(51) Int. Cl. H04W 74/08; H04W 72/14; H04W 72/12; H04L 27/26

(52) U.S. Cl. CPC H04W 74/0816; H04W 74/0866; H04W 72/14; H04W 72/1263; H04W 72/1242; H04L 27/2605

(57) ABSTRACT

Methods, a terminal device and a network node are disclosed for uplink transmission. The terminal device receives, from a network node, a configured grant that indicates resources occupying at least a guard band. The terminal device performs an uplink transmission to the network node using at least the guard band.

### TECHNICAL FIELD

Embodiments of the disclosure generally relate to wireless communication, and, more particularly, to methods, a terminal device and a network node for uplink transmission.

### BACKGROUND

This section introduces aspects that may facilitate better understanding of the present disclosure. Accordingly, the statements of this section are to be read in this light and are not to be understood as admissions about what is in the prior art or what is not in the prior art.

Next generation systems are expected to support a wide range of use cases with varying requirements ranging from fully mobile devices to stationary Internet of things (IoT) or fixed wireless broadband devices. The traffic pattern associated with many use cases is expected to consist of short or long bursts of data traffic with varying length of waiting period in between (here called inactive state). In new radio (NR), both license assisted access and standalone unlicensed operation are to be supported in 3rd generation partnership project (3GPP).

In order to tackle with the ever increasing data demanding, NR is considered both licensed and unlicensed spectrum. Compared to the long term evolution (LTE) licensed assisted access (LAA), NR-based access to unlicensed spectrum (NR-U) also needs to support dual connectivity (DC) and standalone scenarios, where the media access control (MAC) procedures including random access channel (RACH) and scheduling procedure on unlicensed spectrum are subject to the listen before talk (LBT) failures, while there is no such restriction in LTE LAA, since there is licensed spectrum in LAA scenario so the RACH and scheduling related signaling can be transmitted on the licensed spectrum instead of unlicensed spectrum.

For discovery reference signal (DRS) transmission such as primary synchronization signal (PSS)/secondary synchronization signal (SSS), physical broadcast channel (PBCH), channel state information reference signal (CSI-RS), control channel transmission such as physical uplink control channel (PUCCH)/physical downlink control channel (PDCCH), physical data channel such as physical uplink shared channel (PUSCH)/physical downlink shared channel (PDSCH), and uplink sounding reference signal such as sounding reference signal (SRS) transmission, channel sensing should be applied to determine the channel availability before the physical signal is transmitted using the channel.

The radio resource management (RRM) procedures in NR-U would be generally rather similar as in LAA, since NR-U is aiming to reuse LAA/enhanced LAA (eLAA)/further enhanced LAA (feLAA) technologies as much as possible to handle the coexistence between NR-U and other legacy radio access technologies (RATs). RRM measurements and report comprise special configuration procedure with respect to the channel sensing and channel availability.

Hence, channel access/selection for LAA is one of important aspects for co-existence with other RATs such as Wi-Fi. For instance, LAA has aimed to use carriers that are congested with Wi-Fi.

In licensed spectrum, user equipment (UE) measures Reference Signal Received Power (RSRP), and Reference Signal Received Quality (RSRQ) of the downlink radio channel (e.g. synchronization signal (SS) and PBCH block simply referred to as SSB, CSI-RS), and provides the measurement reports to its serving evolved node B (eNB)/next generation node B (gNB). However, they do not reflect the interference strength on the carrier. Another metric Received Signal Strength Indicator (RSSI) can serve for such purpose. At the eNB/gNB side, it is possible to derive RSSI based on the received RSRP and RSRQ reports. However, this requires that they must be available. Due to the LBT failure, some reports in terms of RSRP or RSRQ may be blocked (can be either due to that the reference signal transmission (DRS) is blocked in the downlink or the measurement report is blocked in the uplink). Hence, the measurements in terms of RSSI are very useful. The RSSI measurements together with the time information concerning when and how long time that UEs have made the measurements can assist the gNB/eNB to detect the hidden node. Additionally, the gNB/eNB can measure the load situation of the carrier which is useful for the network to prioritize some channels for load balance and channel access failure avoidance purposes.

LTE LAA has defined to support measurements of averaged RSSI and channel occupancy for measurement reports. The channel occupancy is defined as percentage of time that RSSI is measured above a configured threshold. For this purpose, a RSSI measurement timing configuration (RMTC) includes a measurement duration (e.g. 1-5 ms) and a period between measurements (e.g. {40, 80, 160, 320, 640} ms).

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for uplink transmission.

According to a first aspect of the disclosure, there is provided a method in a terminal device. The method may comprise receiving, from a network node, a configured grant that indicates resources occupying at least a guard band. The method may further comprise performing an uplink transmission to the network node using at least the guard band.

In this way, the resource utilization efficiency in the case of configured scheduling can be enhanced.

In an embodiment of the disclosure, the resources indicated by the configured grant may further occupy a subband adjacent to the guard band. The uplink transmission may be performed using the guard band and the subband adjacent to the guard band.

In an embodiment of the disclosure, a location and a size of the guard band may be signaled from the network node.

In an embodiment of the disclosure, a location and a size of the guard band may be preconfigured.

In an embodiment of the disclosure, the configured grant may be received in a configured grant configuration. The configured grant configuration may indicate that the resources indicated by the configured grant are overlapped with the guard band.

In an embodiment of the disclosure, the configured grant may be received in a configured grant configuration. The configured grant configuration may indicate that the resources indicated by the configured grant are within the guard band.

In an embodiment of the disclosure, the method may further comprise performing LBT operations for subbands associated with the guard band. The uplink transmission may be performed based on results of the LBT operations.

In an embodiment of the disclosure, the LBT operations may be performed for two subbands adjacent to the guard band. The uplink transmission may be performed when the results of the LBT operations indicate that the two subbands are available for the terminal device.

In an embodiment of the disclosure, the subbands associated with the guard band may be indicated by the network node as available for channel occupancy time (COT) sharing. Part of a downlink COT is able to be shared with configured grant based transmissions. A location and a size of the guard band may be indicated by the network node as available for an uplink transmission.

In an embodiment of the disclosure, the subbands and the location and the size of the guard band may be indicated by the network node in one or more of: COT structure information signaling; radio resource control (RRC) signaling; media access control (MAC) control element (CE); and downlink control information (DCI).

In an embodiment of the disclosure, performing the uplink transmission using at least the guard band may comprise mapping first, at least one code block group (CBG) to physical resource blocks (PRBs) occupying the guard band. The first, at least one CBG may be different from second, at least one CBG mapped to PRBs not occupying the guard band. Alternatively, performing the uplink transmission using at least the guard band may comprise mapping first, at least one logical channel to PRBs occupying the guard band. The first, at least one logical channel may have lower priority than second, at least one logical channel mapped to PRBs not occupying the guard band.

In an embodiment of the disclosure, the method may further comprise transmitting, to the network node, an indication about the uplink transmission using at least the guard band.

In an embodiment of the disclosure, the indication about the uplink transmission may comprise a first indicator indicating whether there is an uplink transmission in a guard band.

In an embodiment of the disclosure, the first indicator for a subband may comprise two bits indicating whether there is an uplink transmission in an upper guard band and a lower guard band of the subband respectively.

In an embodiment of the disclosure, the indication about the uplink transmission may further comprise a second indicator indicating a location and a size of the guard band.

In an embodiment of the disclosure, the indication about the uplink transmission may be transmitted to the network node in uplink control information (UCI).

In an embodiment of the disclosure, the method may further comprise determining whether to enable the use of a guard band for an uplink transmission, based on current channel occupancy or LBT failure statistics measured by the terminal device.

In an embodiment of the disclosure, the method may further comprise providing user data and forwarding the user data to a host computer via the transmission to the base station.

According to a second aspect of the disclosure, there is provided a method in a network node. The method may comprise transmitting, to a terminal device, a first configured grant that indicates resources occupying at least a first guard band. The method may further comprise receiving an uplink transmission from the terminal device in at least the first guard band.

In this way, the resource utilization efficiency in the case of configured scheduling can be enhanced.

In an embodiment of the disclosure, the resources indicated by the first configured grant may further occupy a first subband adjacent to the first guard band. The uplink transmission may be received in the first guard band and the first subband.

In an embodiment of the disclosure, the method may further comprise transmitting, to the terminal device, information about locations and sizes of one or more guard bands including the first guard band.

In an embodiment of the disclosure, the first configured grant may be transmitted in a configured grant configuration. The configured grant configuration may indicate, for each of one or more configured grants including the first configured grant, whether resources indicated by the configured grant are overlapped with a guard band.

In an embodiment of the disclosure, the first configured grant may be transmitted in a configured grant configuration. The configured grant configuration may indicate, for each of one or more configured grants including the first configured grant, whether resources indicated by the configured grant are within a guard band.

In an embodiment of the disclosure, the method may further comprise indicating, to the terminal device, multiple subbands available for COT sharing. Part of a downlink COT is able to be shared with configured grant based transmissions. The method may further comprise indicating, to the terminal device for each of one or more guard bands including the first guard band, whether the guard band is available for an uplink transmission.

In an embodiment of the disclosure, the multiple subbands and the one or more guard bands may be indicated by the network node in one or more of: COT structure information signaling; RRC signaling; MAC CE; and DCI.

In an embodiment of the disclosure, the method may further comprise receiving, from the terminal device, an indication about the uplink transmission using at least the first guard band.

In an embodiment of the disclosure, the indication about the uplink transmission may comprise a first indicator indicating whether there is an uplink transmission in a guard band.

In an embodiment of the disclosure, the first indicator for a subband may comprise two bits indicating whether there is an uplink transmission in an upper guard band and a lower guard band of the subband respectively.

In an embodiment of the disclosure, the indication about the uplink transmission may further comprise a second indicator indicating a location and a size of the first guard band.

In an embodiment of the disclosure, the indication about the uplink transmission may be received from the terminal device in UCI.

In an embodiment of the disclosure, whether or not to use a guard band for an uplink transmission may be configured per cell/carrier/bandwidth part (BWP).

In an embodiment of the disclosure, whether or not to use a guard band for an uplink transmission may be configured per terminal device/service/logical channel/logical channel group.

According to a third aspect of the disclosure, there is provided a terminal device. The terminal device may comprise at least one processor and at least one memory. The at least one memory may contain instructions executable by the at least one processor, whereby the terminal device may be operative to receive, from a network node, a configured grant that indicates resources occupying at least a guard band. The terminal device may be further operative to perform an uplink transmission to the network node using at least the guard band.

In an embodiment of the disclosure, the terminal device may be operative to perform the method according to the above first aspect.

According to a fourth aspect of the disclosure, there is provided a network node. The network node may comprise at least one processor and at least one memory. The at least one memory may contain instructions executable by the at least one processor, whereby the network node may be operative to transmit, to a terminal device, a first configured grant that indicates resources occupying at least a first guard band. The network node may be further operative to receive an uplink transmission from the terminal device in at least the first guard band.

In an embodiment of the disclosure, the network node may be operative to perform the method according to the above second aspect.

According to a fifth aspect of the disclosure, there is provided a computer program product. The computer program product may comprise instructions which when executed by at least one processor, cause the at least one processor to perform the method according to any of the above first and second aspects.

According to a sixth aspect of the disclosure, there is provided a computer readable storage medium. The computer readable storage medium may comprise instructions which when executed by at least one processor, cause the at least one processor to perform the method according to any of the above first and second aspects.

According to a seventh aspect of the disclosure, there is provided a terminal device. The terminal device may comprise a reception module for receiving, from a network node, a configured grant that indicates resources occupying at least a guard band. The terminal device may further comprise a transmission module for performing an uplink transmission to the network node using at least the guard band.

According to an eighth aspect of the disclosure, there is provided a network node. The network node may comprise a transmission module for transmitting, to a terminal device, a first configured grant that indicates resources occupying at least a first guard band. The network node may further comprise a reception module for receiving an uplink transmission from the terminal device in at least the first guard band.

According to a ninth aspect of the disclosure, there is provided a method implemented in a communication system including a host computer, a base station and a terminal device. The method may comprise, at the host computer, receiving user data transmitted to the base station from the terminal device. The terminal device may receive, from a base station, a configured grant that indicates resources occupying at least a guard band. The terminal device may perform an uplink transmission to the base station using at least the guard band.

In an embodiment of the disclosure, the method may further comprise, at the terminal device, providing the user data to the base station.

In an embodiment of the disclosure, the method may further comprise, at the terminal device, executing a client application, thereby providing the user data to be transmitted. The method may further comprise, at the host computer, executing a host application associated with the client application.

In an embodiment of the disclosure, the method may further comprise, at the terminal device, executing a client application. The method may further comprise, at the terminal device, receiving input data to the client application. The input data may be provided at the host computer by executing a host application associated with the client application. The user data to be transmitted may be provided by the client application in response to the input data.

According to a tenth aspect of the disclosure, there is provided a communication system including a host computer comprising a communication interface configured to receive user data originating from a transmission from a terminal device to a base station. The terminal device may comprise a radio interface and processing circuitry. The processing circuitry of the terminal device may be configured to receive, from a base station, a configured grant that indicates resources occupying at least a guard band. The processing circuitry of the terminal device may be further configured to perform an uplink transmission to the base station using at least the guard band.

In an embodiment of the disclosure, the communication system may further include the terminal device.

In an embodiment of the disclosure, the communication system may further include the base station. The base station may comprise a radio interface configured to communicate with the terminal device and a communication interface configured to forward to the host computer the user data carried by a transmission from the terminal device to the base station.

In an embodiment of the disclosure, the processing circuitry of the host computer may be configured to execute a host application. The processing circuitry of the terminal device may be configured to execute a client application associated with the host application, thereby providing the user data.

In an embodiment of the disclosure, the processing circuitry of the host computer may be configured to execute a host application, thereby providing request data. The processing circuitry of the terminal device may be configured to execute a client application associated with the host application, thereby providing the user data in response to the request data.

According to an eleventh aspect of the disclosure, there is provided a method implemented in a communication system including a host computer, a base station and a terminal device. The method may comprise, at the host computer, receiving, from the base station, user data originating from a transmission which the base station has received from the terminal device. The base station may transmit, to a terminal device, a first configured grant that indicates resources occupying at least a first guard band. The base station may receive an uplink transmission from the terminal device in at least the first guard band.

In an embodiment of the disclosure, the method may further comprise, at the base station, receiving the user data from the terminal device.

In an embodiment of the disclosure, the method may further comprise, at the base station, initiating a transmission of the received user data to the host computer.

According to a twelfth aspect of the disclosure, there is provided a communication system including a host computer comprising a communication interface configured to receive user data originating from a transmission from a terminal device to a base station. The base station may comprise a radio interface and processing circuitry. The base station's processing circuitry may be configured to transmit, to a terminal device, a first configured grant that indicates resources occupying at least a first guard band. The base station's processing circuitry may be further configured to receive an uplink transmission from the terminal device in at least the first guard band.

In an embodiment of the disclosure, the communication system may further include the base station.

In an embodiment of the disclosure, the communication system may further include the terminal device. The terminal device may be configured to communicate with the base station.

In an embodiment of the disclosure, the processing circuitry of the host computer may be configured to execute a host application. The terminal device may be configured to execute a client application associated with the host application, thereby providing the user data to be received by the host computer.

According to a thirteenth aspect of the disclosure, there is provided a method implemented in a communication system including a network node and a terminal device. The method may comprise, at the network node, transmitting, to the terminal device, a first configured grant that indicates resources occupying at least a first guard band. The method may further comprise, at the terminal device, receiving, from the network node, the configured grant that indicates resources occupying at least the first guard band. The method may further comprise, at the terminal device, performing an uplink transmission to the network node using at least the first guard band. The method may further comprise, at the network node, receiving the uplink transmission from the terminal device in at least the first guard band.

According to a fourteenth aspect of the disclosure, there is provided a communication system comprising a network node and a terminal device. The network node may be configured to transmit, to a terminal device, a first configured grant that indicates resources occupying at least a first guard band, and receive an uplink transmission from the terminal device in at least the first guard band. The terminal device may be configured to receive, from the network node, the configured grant that indicates resources occupying at least the first guard band, and perform the uplink transmission to the network node using at least the first guard band.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 illustrates transmission opportunities with and without COT sharing;

FIG. 2 illustrates a wideband carrier containing a BWP with four subbands;

FIG. 3 illustrates configured grant configurations according to an embodiment of the disclosure;

FIG. 4 is a flowchart illustrating an exemplary process according to an embodiment of the disclosure;

FIG. 5 is a flowchart illustrating a method implemented at a terminal device according to an embodiment of the disclosure;

FIG. 6 is a flowchart illustrating a method implemented at a terminal device according to another embodiment of the disclosure;

FIG. 7 is a flowchart illustrating a method implemented at a network node according to an embodiment of the disclosure;

FIG. 8 is a flowchart illustrating a method implemented at a network node according to another embodiment of the disclosure;

FIG. 9 is a flowchart illustrating a method implemented at a network node according to another embodiment of the disclosure;

FIG. 10 is a block diagram showing an apparatus suitable for use in practicing some embodiments of the disclosure;

FIG. 11 is a block diagram showing a terminal device according to an embodiment of the disclosure;

FIG. 12 is a block diagram showing a network node according to an embodiment of the disclosure;

FIG. 13 is a diagram showing a telecommunication network connected via an intermediate network to a host computer in accordance with some embodiments;

FIG. 14 is a diagram showing a host computer communicating via a base station with a user equipment in accordance with some embodiments;

FIG. 15 is a flowchart illustrating a method implemented in a communication system in accordance with some embodiments;

FIG. 16 is a flowchart illustrating a method implemented in a communication system in accordance with some embodiments;

FIG. 17 is a flowchart illustrating a method implemented in a communication system in accordance with some embodiments; and

FIG. 18 is a flowchart illustrating a method implemented in a communication system in accordance with some embodiments.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

For a node (e.g., NR-U gNB/UE, LTE-LAA eNB/UE, or Wi-Fi access point (AP)/station (STA)) to be allowed to transmit in unlicensed spectrum (e.g., 5 GHz band), it typically needs to perform a clear channel assessment (CCA). This procedure typically includes sensing the medium to be idle for a number of time intervals. Sensing the medium to be idle can be done in different ways, e.g. using energy detection, preamble detection or using virtual carrier sensing. The latter implies that the node reads control information from other transmitting nodes informing when a transmission ends. After sensing the medium to be idle, the node is typically allowed to transmit for a certain amount of time, sometimes referred to as transmission opportunity (TXOP). The length of the TXOP depends on regulation and type of CCA that has been performed, but typically ranges from 1 ms to 10 ms. This duration is often referred to as Channel Occupancy Time (COT).

In Wi-Fi, feedback of data reception acknowledgements (ACKs) is transmitted without performing clear channel assessment. Preceding feedback transmission, a small time duration (called SIFS) is introduced between the data transmission and the corresponding feedback which does not include actual sensing of the channel. In 802.11, the SIFS period (16 μs for 5 GHz orthogonal frequency division multiplexing (OFDM) PHYs) is defined as:

aSIFSTime=aRxPHYDelay+aMACProcessingDelay+aRxTxTurnaroundTime

where aRxPHYDelay defines the duration needed by the physical (PHY) layer to deliver a packet to the MAC layer, aMACProcessingDelay defines the duration that the MAC layer needs to trigger the PHY layer transmitting a response, and aRxTxTurnaroundTime defines the duration needed to turn the radio from reception into transmission mode. Therefore, the SIFS duration is used to accommodate for the hardware delay to switch the direction from reception to transmission.

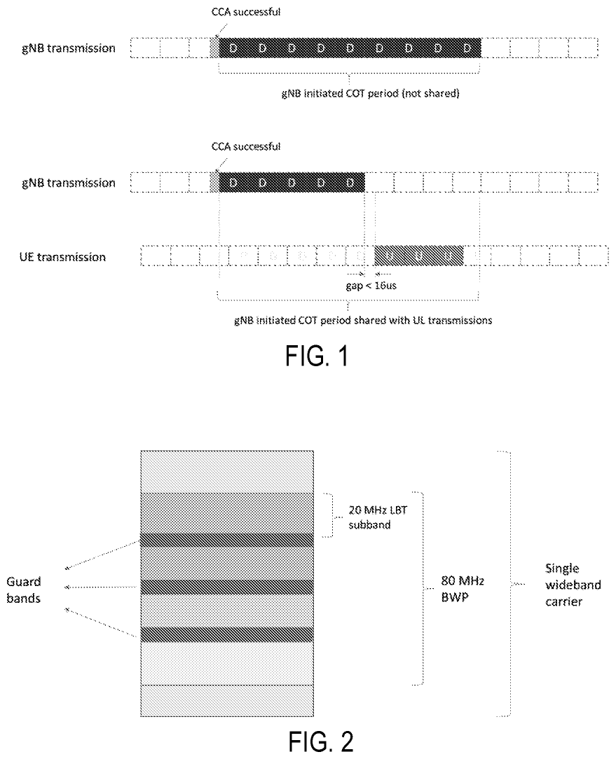

It is anticipated that for NR in unlicensed bands (NR-U), a similar gap to accommodate for the radio turnaround time will be allowed. For example, this will enable the transmission of PUCCH carrying uplink control information (UCI) feedback as well as PUSCH carrying data and possible UCI within the same transmit opportunity (TXOP) acquired by the initiating gNB without the UE performing clear channel assessment before PUSCH/PUCCH transmission as long as the gap between downlink (DL) and uplink (UL) transmission is less than or equal to 16 μs. Operation in this manner is typically called “COT sharing.” An example on COT sharing is illustrated in FIG. 1. It shows TXOP both with and without COT sharing where CCA is performed by the initiating node (gNB). For the case of COT sharing, the gap between DL and UL transmissions is less than 16 μs.

Listen-before-talk (LBT) is designed for unlicensed spectrum co-existence with other RATs. In this mechanism, a radio device applies a clear channel assessment (CCA) check (i.e. channel sensing) before any transmission. The transmitter involves energy detection (ED) over a time period compared to a certain energy detection threshold (ED threshold) in order to determine if a channel is idle. In case the channel is determined to be occupied, the transmitter performs a random back-off within a contention window before next CCA attempt. In order to protect the ACK transmissions, the transmitter must defer a period after each busy CCA slot prior to resuming back-off. As soon as the transmitter has grasped access to a channel, the transmitter is only allowed to perform transmission up to a maximum time duration (namely, the maximum channel occupancy time (MCOT)). For quality of service (QoS) differentiation, a channel access priority based on the service type has been defined. For example, there are four LBT priority classes defined for differentiation of channel access priorities between services using contention window size (CWS) and MCOT duration.

The channel access schemes for NR-based access for unlicensed spectrum can be classified into the following categories. Category 1 is immediate transmission after a short switching gap. This is used for a transmitter to immediately transmit after a UL/DL switching gap inside a COT. The switching gap from reception to transmission is to accommodate the transceiver turnaround time and is no longer than 16 μs. Category 2 is LBT without random back-off. The duration of time that the channel is sensed to be idle before the transmitting entity transmits is deterministic.

Category 3 is LBT with random back-off with a contention window of fixed size. The LBT procedure has the following procedure as one of its components. The transmitting entity draws a random number N within a contention window. The size of the contention window is specified by the minimum and maximum value of N. The size of the contention window is fixed. The random number N is used in the LBT procedure to determine the duration of time that the channel is sensed to be idle before the transmitting entity transmits on the channel.

Category 4 is LBT with random back-off with a contention window of variable size. The LBT procedure has the following as one of its components. The transmitting entity draws a random number N within a contention window. The size of contention window is specified by the minimum and maximum value of N. The transmitting entity can vary the size of the contention window when drawing the random number N. The random number N is used in the LBT procedure to determine the duration of time that the channel is sensed to be idle before the transmitting entity transmits on the channel. For different transmissions in a COT and different channels/signals to be transmitted, different categories of channel access schemes can be used.

As for NR in licensed bands, it is expected that NR-U will support transmissions over a wide bandwidth (>>20 MHz), which is configured with multiple LBT subbands and each of them contains 20 MHz. In this case, a UE may not grasp all configured LBT subbands due to the LBT failures prior to a transmission.

Two possible approaches (namely alternative 1 (Alt. 1) and Alt. 2) for UL transmissions in a wideband carrier may be used. For UL transmissions in a serving cell with carrier bandwidth greater than LBT bandwidth, for the case where UE performs CCA before UL transmission, at least Alt. 1 may be supported among the following alternatives. In Alt. 1, UE transmits the PUSCH only if CCA is successful at UE in all LBT bandwidths of the scheduled PUSCH. In Alt. 2, UE transmits the PUSCH in all or a subset of LBT bandwidths of the scheduled PUSCH for which CCA is successful at the UE.

In a wideband carrier, a guard band is required to be configured between two adjacent LBT subbands, to avoid/mitigate LBT operation and receiver performance to be negatively impacted by potential in-carrier leakage. Guard band requirements, e.g., minimum bandwidth, absolute location, etc. may then be defined accordingly. It may be desirable that the guard bands are configured in a bandwidth part (BWP) as integer multiplies of physical resource block (PRB). An example of a wideband carrier containing multiple LBT subbands is illustrated in FIG. 2.

In NR, configured scheduling is used to allocate semi-static periodic assignments or grants for a UE. For uplink, there are two types of configured scheduling schemes: Type 1 and Type 2. For Type 1, configured grants are configured via radio resource control (RRC) signaling only. For Type 2, similar configuration procedure as semi-persistent scheduling (SPS) uplink (UL) in LTE was defined, i.e. some parameters are preconfigured via RRC signaling and some physical layer parameters are configured via MAC scheduling procedure. The detail procedures can be found in 3GPP technical specification (TS) 38.321 V15.4.0. The configured uplink scheduling will be also used in NR unlicensed operation. For NR-U, the configured scheduling can improve the channel access probability for PUSCH transmission because additional LBT for PDCCH transmission per UL grant is avoided and the UE can acquire channel for PUSCH transmission using a configured grant after LBT success. In this uplink transmission procedure, only single LBT procedure is needed compared to 3 LBT procedures (one for scheduling request (SR) transmission (TX), one for PDCCH for UL grant and one for PUSCH TX) relying on SR/buffer status report (BSR) procedure. This can significantly improve the channel access probability for PUSCH transmission.

Allowing consecutive configured grant resources in time without any gaps in between the resources and non-consecutive configured grant resources (not necessarily periodic) with gaps in between the resources is beneficial.

In carrier aggregation, each carrier component (CC) has a guard band defined by RAN4. However, from RAN4 perspective, there is no requirement that the guard bands between two or more contiguous carriers are left empty. Hence, optimizations may be considered whereby the transmitting device uses the guard PRBs and the receiving device assumes that data symbols are mapped to these PRBs.

For a wideband carrier/BWP containing multiple LBT subbands, once the guard bands are needed, the default BWP configuration should skip all the guard bands assuming all the adjacent subbands are not available for data transmission and reception. Specifically, for a configured grant configuration of a UE, the allocated configured grant by the gNB would skip the guard bands, which reduces the spectral utilization efficiency.

However, when two adjacent subbands are both available, the guard band between them may not be needed. In other words, the guard bands can be utilized for transmission or reception in such cases which can improve the resource utilization efficiency. Because the gNB is not aware of LBT results for UL transmissions since the LBT operation is performed at the UE side, in order to utilize the guard bands for UL configured grant based transmissions, the UE must report the LBT results to its serving gNB. After that, the gNB can reconfigure configured grants to the UE, which is not delay efficient. Therefore, it would be advantageous to study how to utilize the guard bands for UL configured grant based transmissions in case of configured scheduling.

The present disclosure proposes an improved solution for uplink transmission. The solution may be applied to a wireless communication system including a terminal device and a network node such as a base station or any other node with similar functionality. The terminal device can communicate through a radio access communication link with the base station. The base station can provide radio access communication links to terminal devices that are within its communication service cell. Note that the communications may be performed between the terminal device and the base station according to any suitable communication standards and protocols. The terminal device may also be referred to as, for example, device, access terminal, user equipment (UE), mobile station, mobile unit, subscriber station, or the like. It may refer to any end device that can access a wireless communication network and receive services therefrom. By way of example and not limitation, the terminal device may include a portable computer, an image capture terminal device such as a digital camera, a gaming terminal device, a music storage and playback appliance, a mobile phone, a cellular phone, a smart phone, a tablet, a wearable device, a personal digital assistant (PDA), or the like.

In an Internet of things (IoT) scenario, a terminal device may represent a machine or other device that performs monitoring and/or measurements, and transmits the results of such monitoring and/or measurements to another terminal device and/or a network equipment. In this case, the terminal device may be a machine-to-machine (M2M) device, which may, in a 3GPP context, be referred to as a machine-type communication (MTC) device. Particular examples of such machines or devices may include sensors, metering devices such as power meters, industrial machineries, bikes, vehicles, or home or personal appliances, e.g. refrigerators, televisions, personal wearables such as watches, and so on.

Now, several embodiments will be described to explain the improved solution for uplink transmission. Although these embodiments will be described in the context of NR-U, the principle of the disclosure is also applicable to other unlicensed operation scenarios such as LTE LAA/eLAA/feLAA/MuLteFire.

As a first embodiment, a UE can be configured with a configured grant in a guard band region. The gNB can indicate if a configured grant is within or overlapped with a guard band in the configured grant configuration. The information on the adjacent subbands associated with the guard band may be also signaled/indicated to the UE. The UE can decide if the configured grant is usable depending on outcome of the LBT operation of the current subband and the adjacent LBT subband to this guard band, i.e. the configured grant in the guard band is usable if the LBT succeeds in both adjacent subbands associated with the guard band. In other words, both adjacent subbands are available for the UE to transmit UL data and/or signaling.

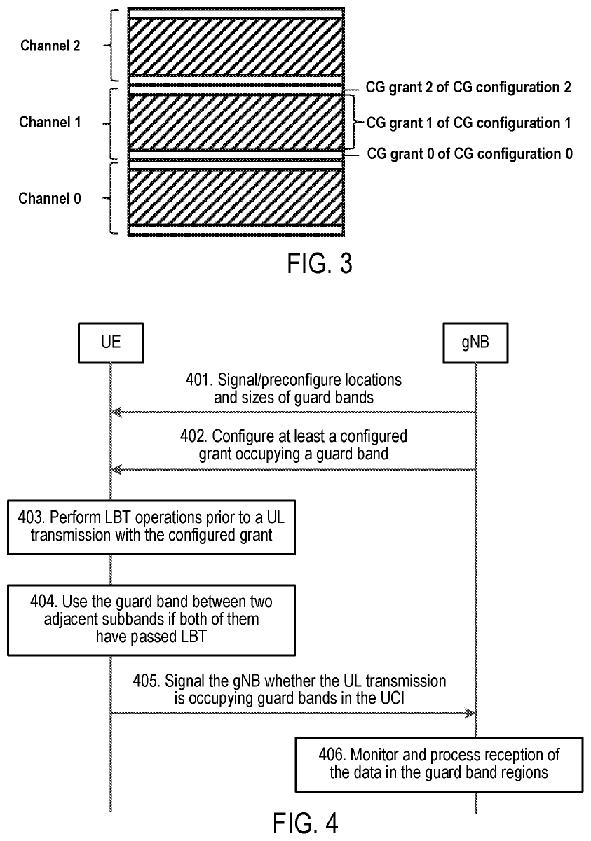

FIG. 3 illustrates an example in which 3 configured grant (CG) grants are configured in the same subband in the same slot (mini-slot) for a UE. If LBT succeeds in Channel 1 and 0 but fails in Channel 2, the UE can use CG grant 0 and 1 for UL transmission. If LBT succeeds in Channel 1 and Channel 2 but fails in Channel 0, the UE can use CG grant 1 and 2 for UL transmission.

As a second embodiment, a configured grant comprising guard band(s) may be configured for a suband and the UE may prepare single MAC protocol data unit (PDU) and map different code block groups (CBGs) to the PRBs not occupying guard bands and to the PRBs in the guard bands separately. In case a guard band is not able to be used, the UE MAC may only retransmit the CBGs that are mapped to the guard band region. As another option, the UE may map logical channels (LCHs) with lower priority to PRBs in a guard band, while mapping LCHs with higher priority to PRBs not overlapped with a guard band.

As a third embodiment, a CG UL transmission may be performed using guard bands as shown in FIG. 4. At block 401, the gNB signals/preconfigures locations and sizes of guard bands to the UE. At block 402, the gNB configures at least a configured grant occupying a guard band to the UE. At block 403, the UE performs LBT operations prior to a UL transmission with the configured grant. At block 404, the UE uses the guard band between two adjacent subbands if both of them have passed LBT. At block 405, the UE signals the gNB whether the UL transmission is occupying guard bands in the UCI. At block 406, the gNB monitors and processes reception of data and/or signaling in the guard band regions.

As a fourth embodiment, in case the gNB has initiated a DL channel occupancy time (COT), which is allowed to be shared with UL configured grant based transmissions during a specific time period, the gNB may not only indicate the subbands that are available for sharing, but also indicate if the guard bands (i.e., the guard band locations and sizes) are available to be used for UL data transfer. The indicators may be carried directly in the COT structure information signaling, or signaled via other signaling means such as RRC, or MAC CE or UE dedicated DCI, etc. Within the period shared for UL transmission, a UE decides whether the guard bands can be used for its data transmission relying on the outcome of the LBT operations. In other words, the guard band between two adjacent subbands is available for UL data transmission only in case both subbands have passed the LBT operations.

As a fifth embodiment, the UE may indicate if there is uplink transmission in a guard band in a UCI (e.g., CG-UCI). Optionally, the information on locations and sizes of guard bands that are occupied may be also carried in the UCI (e.g. CG-UCI). Upon reception of the indicators, the gNB monitors and processes the reception of data and/or signaling in the guard band accordingly. As an example, there may be two bits in the UCI (e.g. CG-UCI) to indicate whether there are UL transmissions in the upper and down guard band of a subband respectively.

As a sixth embodiment, whether or not to use a guard band region for UL transmission may be configured per cell/carrier/BWP. Different options may be configured for different serving cell/carrier/BWP.

As a seventh embodiment, whether or not to use a guard band region for UL transmission may be configured per UE/service/LCH/logical channel group (LCG). As one example, a delay non-sensitive service/LCH/LCG may be configured to use a guard band for UL transmission.

As an eighth embodiment, whether or not to use a guard band region for UL transmission may be enabled or disabled based on measured channel occupancy or LBT statistics. As an example, the UE may be allowed to use a guard band between LBT subbands for UL transmission if the associated cell/BWP/carrier is experiencing low load since in this case, the UE has higher probability to grasp more than one LBT subbands for UL transmissions. As another example, the UE is not allowed to use a guard band for UL transmissions, if the associated cell/BWP/carrier has high channel occupancy meaning that the UE may only be able to grasp a single LBT subband for UL transmissions.

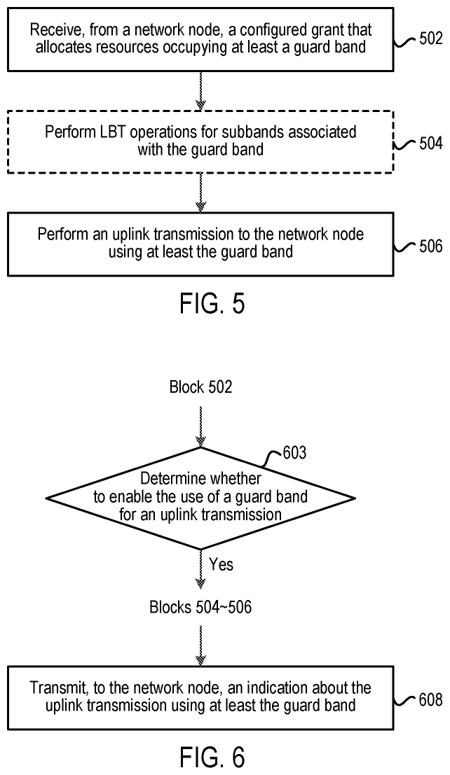

Hereinafter, the solution will be further described with reference to FIGS. 5-18. FIG. 5 is a flowchart illustrating a method implemented at a terminal device according to an embodiment of the disclosure. At block 502, the terminal device receives, from a network node, a configured grant that indicates resources occupying at least a guard band. The network node may be a base station or any other node with similar functionality. The configured grant may be received in a configured grant configuration which indicates that the resources indicated by the configured grant are within or overlapped with the guard band. The location and size of the guard band may be preconfigured or signaled from the network node. Optionally, the resources indicated by the configured grant may further occupy a subband adjacent to the guard band.

At block 504, the terminal device performs LBT operations for subbands associated with the guard band. The subbands associated with the guard band may be two subbands adjacent to the guard band. At block 506, the terminal device performs an uplink transmission to the network node using at least the guard band based on results of the LBT operations. In this way, the resource utilization efficiency in the case of configured scheduling can be enhanced since the guard band can be used for uplink transmission. For example, the uplink transmission may be performed when the results of the LBT operations indicate that the two subbands are available for the terminal device. The uplink transmission may comprise transmission of data and/or signaling. Optionally, if the resources indicated by the configured grant further occupy a subband adjacent to the guard band, the uplink transmission may be performed using the guard band and the subband adjacent to the guard band.

As an option, the uplink transmission may be performed by mapping first, at least one CBG to PRBs occupying the guard band. The first, at least one CBG may be different from second, at least one CBG mapped to PRBs not occupying the guard band. As another option, the uplink transmission may be performed by mapping first, at least one logical channel to PRBs occupying the guard band. The first, at least one logical channel may have lower priority than second, at least one logical channel mapped to PRBs not occupying the guard band.

As an exemplary example, the subbands associated with the guard band may be indicated by the network node as available for COT sharing. Part of a downlink COT is able to be shared with configured grant based transmissions. The location and size of the guard band may be indicated by the network node as available for an uplink transmission. In this case, blocks 504 and 506 may be performed. The subbands and the location and the size of the guard band may be indicated by the network node in one or more of: COT structure information signaling, RRC signaling, MAC CE, and DCI.

As mentioned above, the channel access schemes for NR-based access for unlicensed spectrum can be classified into four categories (see 3GPP TR 38.889 V16.0.0). Category 1 is immediate transmission after a short switching gap. This is used for a transmitter to immediately transmit after a UL/DL switching gap inside a COT. The switching gap from reception to transmission is to accommodate the transceiver turnaround time and is no longer than 16 μs. Therefore, for category 1 channel access/LBT option, UE can skip the LBT if the UL/DL switching gap is not longer than 16 μs. In other words, it is possible that in case a COT is initiated by the gNB and shared with UE, UE can skip the LBT operation for UL transmission if the DL-UL gap is not more than 16 μs. This means block 504 may be an optional block.

Therefore, at least one embodiment of the present disclosure provides a method in a terminal device. The method comprises receiving, from a network node, a configured grant that indicates resources occupying at least a guard band, and performing an uplink transmission to the network node using at least the guard band.

FIG. 6 is a flowchart illustrating a method implemented at a terminal device according to another embodiment of the disclosure. At block 502, the terminal device receives, from a network node, a configured grant that indicates resources occupying at least a guard band. At block 603, the terminal device determines whether to enable the use of a guard band for an uplink transmission, based on current channel occupancy or LBT failure statistics measured by the terminal device. For example, the use of the guard band may be enabled if the current channel occupancy or LBT failure probability is low. The use of the guard band may be disabled if the current channel occupancy or LBT failure probability is high.

If it is determined to enable the use of the guard band, blocks 504 and 506 may be performed. At block 608, the terminal device transmits, to the network node, an indication about the uplink transmission using at least the guard band. The indication about the uplink transmission may comprise a first indicator indicating whether there is an uplink transmission in a guard band. For example, the first indicator for a subband may comprise two bits indicating whether there is an uplink transmission in an upper guard band and a lower guard band of the subband respectively. The upper guard band refers to the guard band adjacent to the upper edge of the subband (or channel). The lower guard band refers to the guard band adjacent to the lower edge of the subband (or channel). Optionally, the indication about the uplink transmission may further comprise a second indicator indicating a location and a size of the guard band. The indication about the uplink transmission may be transmitted to the network node in UCI such as CG-UCI.

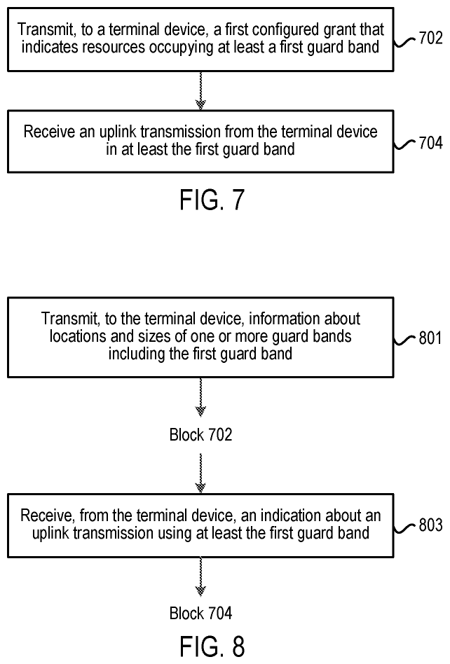

FIG. 7 is a flowchart illustrating a method implemented at a network node according to an embodiment of the disclosure. The network node may be a base station or any other node with similar functionality. At block 702, the network node transmits, to a terminal device, a first configured grant that indicates resources occupying at least a first guard band. Optionally, the resources indicated by the first configured grant may further occupy a first subband adjacent to the first guard band. The first configured grant may be transmitted in a configured grant configuration. The configured grant configuration may indicate, for each of one or more configured grants including the first configured grant, whether resources indicated by the configured grant are within or overlapped with a guard band. Optionally, whether or not to use a guard band for an uplink transmission may be configured per cell/carrier/BWP. Alternatively, whether or not to use a guard band for an uplink transmission may be configured per terminal device/service/logical channel/logical channel group.

At block 704, the network node receives an uplink transmission from the terminal device in at least the first guard band. For example, the uplink transmission may be received by monitoring the first guard band. If the signal transmitted in the first guard band is not from a competing system (e.g. Wi-Fi), the network node may process the signal. Optionally, if the resources indicated by the first configured grant further occupy a first subband adjacent to the first guard band, the uplink transmission may be received in the first guard band and the first subband.

FIG. 8 is a flowchart illustrating a method implemented at a network node according to another embodiment of the disclosure. At block 801, the network node transmits, to the terminal device, information about locations and sizes of one or more guard bands including the first guard band. At block 702, the network node transmits, to a terminal device, a first configured grant that indicates resources occupying at least a first guard band. At block 803, the network node receives, from the terminal device, an indication about the uplink transmission using at least the first guard band. The indication about the uplink transmission may comprise a first indicator indicating whether there is an uplink transmission in a guard band. For example, the first indicator for a subband may comprise two bits indicating whether there is an uplink transmission in an upper guard band and a lower guard band of the subband respectively. Optionally, the indication about the uplink transmission may further comprise a second indicator indicating a location and a size of the first guard band. The indication about the uplink transmission may be received from the terminal device in UCI such as CG-UCI. In response to the indication, the network node receives an uplink transmission from the terminal device in at least the first guard band at block 704.

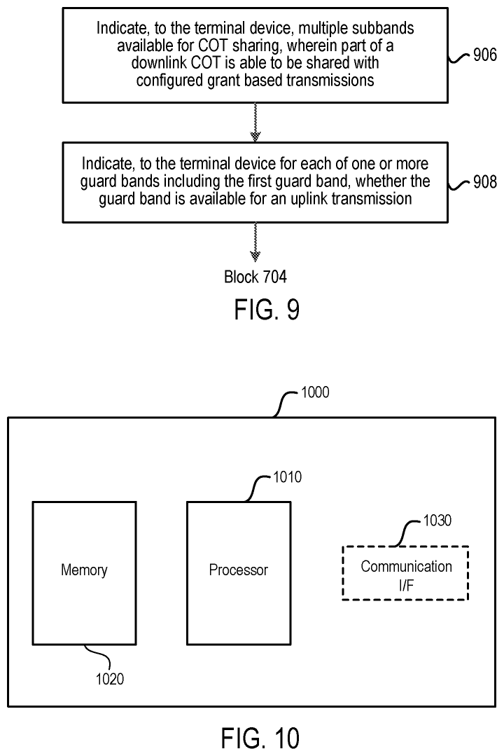

FIG. 9 is a flowchart illustrating a method implemented at a network node according to another embodiment of the disclosure. At block 906, the network node indicates, to the terminal device, multiple subbands available for COT sharing. Part of a downlink COT is able to be shared with configured grant based transmissions. At block 908, the network node indicates, to the terminal device for each of one or more guard bands including the first guard band, whether the guard band is available for an uplink transmission. For example, the multiple subbands and the one or more guard bands may be indicated by the network node in one or more of: COT structure information signaling, RRC signaling, MAC CE, and DCI. At block 704, the network node receives an uplink transmission from the terminal device in at least the first guard band. It should be noted that two blocks shown in succession in the figures may, in fact, be executed substantially concurrently, or the blocks may sometimes be executed in the reverse order, depending upon the functionality involved.

Based on the above description, at least one aspect of the present disclosure provides a method implemented in a communication system including a network node and a terminal device. The method comprises, at the network node, transmitting, to the terminal device, a first configured grant that indicates resources occupying at least a first guard band. The method further comprises, at the terminal device, receiving, from the network node, the configured grant that indicates resources occupying at least the first guard band. The method further comprises, at the terminal device, performing an uplink transmission to the network node using at least the first guard band. The method further comprises, at the network node, receiving the uplink transmission from the terminal device in at least the first guard band.

FIG. 10 is a block diagram showing an apparatus suitable for use in practicing some embodiments of the disclosure. For example, any one of the terminal device and the network node described above may be implemented through the apparatus 1000. As shown, the apparatus 1000 may include a processor 1010, a memory 1020 that stores a program, and optionally a communication interface 1030 for communicating data with other external devices through wired and/or wireless communication.

The program includes program instructions that, when executed by the processor 1010, enable the apparatus 1000 to operate in accordance with the embodiments of the present disclosure, as discussed above. That is, the embodiments of the present disclosure may be implemented at least in part by computer software executable by the processor 1010, or by hardware, or by a combination of software and hardware.

The memory 1020 may be of any type suitable to the local technical environment and may be implemented using any suitable data storage technology, such as semiconductor based memory devices, flash memories, magnetic memory devices and systems, optical memory devices and systems, fixed memories and removable memories. The processor 1010 may be of any type suitable to the local technical environment, and may include one or more of general purpose computers, special purpose computers, microprocessors, digital signal processors (DSPs) and processors based on multi-core processor architectures, as non-limiting examples.

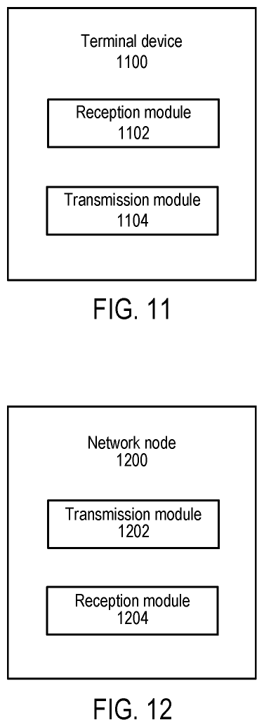

FIG. 11 is a block diagram showing a terminal device according to an embodiment of the disclosure. As shown, the terminal device 1100 comprises a reception module 1102, an LBT module 1104 and a transmission module 1106. The reception module 1102 may be configured to receive, from a network node, a configured grant that indicates resources occupying at least a guard band, as described above with respect to block 502. The LBT module 1104 may be configured to perform LBT operations for subbands associated with the guard band, as described above with respect to block 504. The transmission module 1106 may be configured to perform an uplink transmission to the network node using at least the guard band based on results of the LBT operations, as described above with respect to block 506.

FIG. 12 is a block diagram showing a network node according to an embodiment of the disclosure. As shown, the network node 1200 comprises a transmission module 1202 and a reception module 1204. The transmission module 1202 may be configured to transmit, to a terminal device, a first configured grant that indicates resources occupying at least a first guard band, as described above with respect to block 702. The reception module 1204 may be configured to receive an uplink transmission from the terminal device in at least the first guard band, as described above with respect to block 704. The modules described above may be implemented by hardware, or software, or a combination of both.

Based on the above description, at least one aspect of the present disclosure provides a communication system comprising a network node and a terminal device. The network node is configured to transmit, to a terminal device, a first configured grant that indicates resources occupying at least a first guard band, and receive an uplink transmission from the terminal device in at least the first guard band. The terminal device is configured to receive, from the network node, the configured grant that indicates resources occupying at least the first guard band, and perform the uplink transmission to the network node using at least the first guard band.

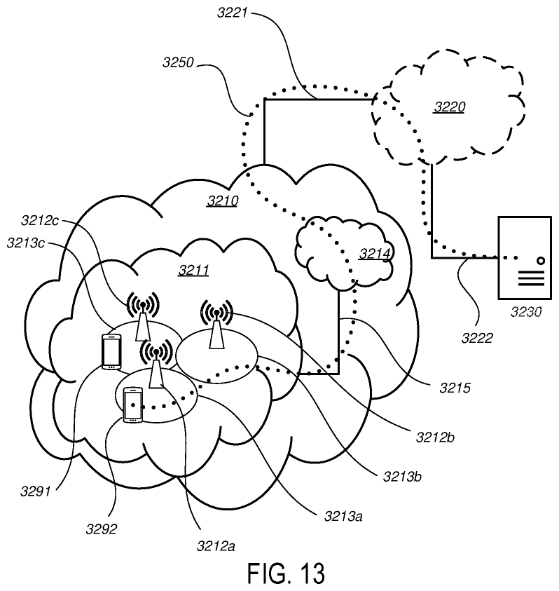

With reference to FIG. 13, in accordance with an embodiment, a communication system includes telecommunication network 3210, such as a 3GPP-type cellular network, which comprises access network 3211, such as a radio access network, and core network 3214. Access network 3211 comprises a plurality of base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

Telecommunication network 3210 is itself connected to host computer 3230, which may be embodied in the hardware and/or software of a standalone server, a cloud-implemented server, a distributed server or as processing resources in a server farm. Host computer 3230 may be under the ownership or control of a service provider, or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more sub-networks (not shown).

The communication system of FIG. 13 as a whole enables connectivity between the connected UEs 3291, 3292 and host computer 3230. The connectivity may be described as an over-the-top (OTT) connection 3250. Host computer 3230 and the connected UEs 3291, 3292 are configured to communicate data and/or signaling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. For example, base station 3212 may not or need not be informed about the past routing of an incoming downlink communication with data originating from host computer 3230 to be forwarded (e.g., handed over) to a connected UE 3291. Similarly, base station 3212 need not be aware of the future routing of an outgoing uplink communication originating from the UE 3291 towards the host computer 3230.

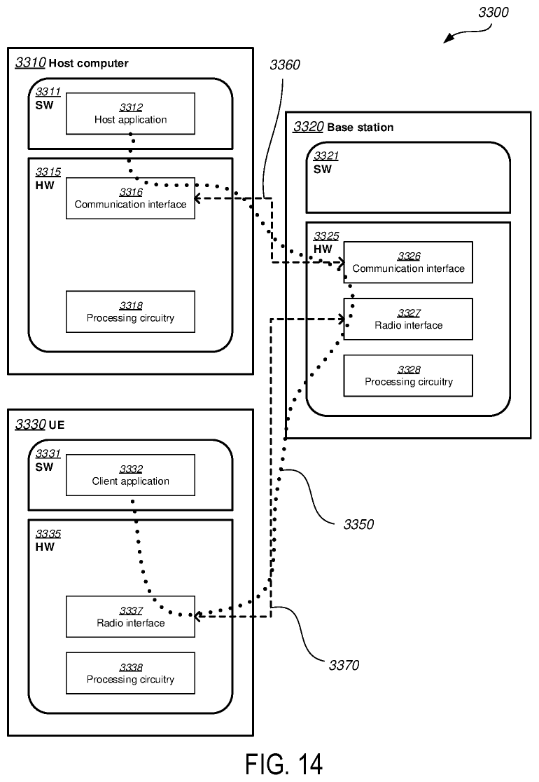

Example implementations, in accordance with an embodiment, of the UE, base station and host computer discussed in the preceding paragraphs will now be described with reference to FIG. 14. In communication system 3300, host computer 3310 comprises hardware 3315 including communication interface 3316 configured to set up and maintain a wired or wireless connection with an interface of a different communication device of communication system 3300. Host computer 3310 further comprises processing circuitry 3318, which may have storage and/or processing capabilities. In particular, processing circuitry 3318 may comprise one or more programmable processors, application-specific integrated circuits, field programmable gate arrays or combinations of these (not shown) adapted to execute instructions. Host computer 3310 further comprises software 3311, which is stored in or accessible by host computer 3310 and executable by processing circuitry 3318. Software 3311 includes host application 3312. Host application 3312 may be operable to provide a service to a remote user, such as UE 3330 connecting via OTT connection 3350 terminating at UE 3330 and host computer 3310. In providing the service to the remote user, host application 3312 may provide user data which is transmitted using OTT connection 3350.

Communication system 3300 further includes base station 3320 provided in a telecommunication system and comprising hardware 3325 enabling it to communicate with host computer 3310 and with UE 3330. Hardware 3325 may include communication interface 3326 for setting up and maintaining a wired or wireless connection with an interface of a different communication device of communication system 3300, as well as radio interface 3327 for setting up and maintaining at least wireless connection 3370 with UE 3330 located in a coverage area (not shown in FIG. 14) served by base station 3320. Communication interface 3326 may be configured to facilitate connection 3360 to host computer 3310. Connection 3360 may be direct or it may pass through a core network (not shown in FIG. 14) of the telecommunication system and/or through one or more intermediate networks outside the telecommunication system. In the embodiment shown, hardware 3325 of base station 3320 further includes processing circuitry 3328, which may comprise one or more programmable processors, application-specific integrated circuits, field programmable gate arrays or combinations of these (not shown) adapted to execute instructions. Base station 3320 further has software 3321 stored internally or accessible via an external connection.

Communication system 3300 further includes UE 3330 already referred to. Its hardware 3335 may include radio interface 3337 configured to set up and maintain wireless connection 3370 with a base station serving a coverage area in which UE 3330 is currently located. Hardware 3335 of UE 3330 further includes processing circuitry 3338, which may comprise one or more programmable processors, application-specific integrated circuits, field programmable gate arrays or combinations of these (not shown) adapted to execute instructions. UE 3330 further comprises software 3331, which is stored in or accessible by UE 3330 and executable by processing circuitry 3338. Software 3331 includes client application 3332. Client application 3332 may be operable to provide a service to a human or non-human user via UE 3330, with the support of host computer 3310. In host computer 3310, an executing host application 3312 may communicate with the executing client application 3332 via OTT connection 3350 terminating at UE 3330 and host computer 3310. In providing the service to the user, client application 3332 may receive request data from host application 3312 and provide user data in response to the request data. OTT connection 3350 may transfer both the request data and the user data. Client application 3332 may interact with the user to generate the user data that it provides.

It is noted that host computer 3310, base station 3320 and UE 3330 illustrated in FIG. 14 may be similar or identical to host computer 3230, one of base stations 3212a, 3212b, 3212c and one of UEs 3291, 3292 of FIG. 13, respectively. This is to say, the inner workings of these entities may be as shown in FIG. 14 and independently, the surrounding network topology may be that of FIG. 13.

In FIG. 14, OTT connection 3350 has been drawn abstractly to illustrate the communication between host computer 3310 and UE 3330 via base station 3320, without explicit reference to any intermediary devices and the precise routing of messages via these devices. Network infrastructure may determine the routing, which it may be configured to hide from UE 3330 or from the service provider operating host computer 3310, or both. While OTT connection 3350 is active, the network infrastructure may further take decisions by which it dynamically changes the routing (e.g., on the basis of load balancing consideration or reconfiguration of the network).

Wireless connection 3370 between UE 3330 and base station 3320 is in accordance with the teachings of the embodiments described throughout this disclosure. One or more of the various embodiments improve the performance of OTT services provided to UE 3330 using OTT connection 3350, in which wireless connection 3370 forms the last segment. More precisely, the teachings of these embodiments may improve the latency and thereby provide benefits such as reduced user waiting time.

A measurement procedure may be provided for the purpose of monitoring data rate, latency and other factors on which the one or more embodiments improve. There may further be an optional network functionality for reconfiguring OTT connection 3350 between host computer 3310 and UE 3330, in response to variations in the measurement results. The measurement procedure and/or the network functionality for reconfiguring OTT connection 3350 may be implemented in software 3311 and hardware 3315 of host computer 3310 or in software 3331 and hardware 3335 of UE 3330, or both. In embodiments, sensors (not shown) may be deployed in or in association with communication devices through which OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of OTT connection 3350 may include message format, retransmission settings, preferred routing etc.; the reconfiguring need not affect base station 3320, and it may be unknown or imperceptible to base station 3320. Such procedures and functionalities may be known and practiced in the art. In certain embodiments, measurements may involve proprietary UE signaling facilitating host computer 3310's measurements of throughput, propagation times, latency and the like. The measurements may be implemented in that software 3311 and 3331 causes messages to be transmitted, in particular empty or ‘dummy’ messages, using OTT connection 3350 while it monitors propagation times, errors etc.

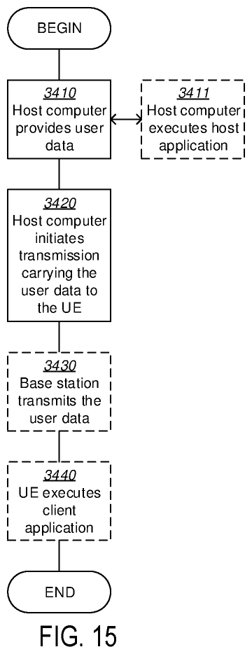

FIG. 15 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 15 will be included in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated, in accordance with the teachings of the embodiments described throughout this disclosure. In step 3440 (which may also be optional), the UE executes a client application associated with the host application executed by the host computer.

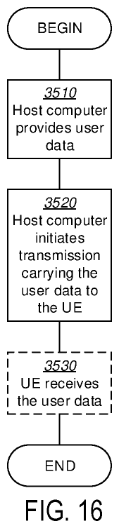

FIG. 16 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 16 will be included in this section. In step 3510 of the method, the host computer provides user data. In an optional substep (not shown) the host computer provides the user data by executing a host application. In step 3520, the host computer initiates a transmission carrying the user data to the UE. The transmission may pass via the base station, in accordance with the teachings of the embodiments described throughout this disclosure. In step 3530 (which may be optional), the UE receives the user data carried in the transmission.

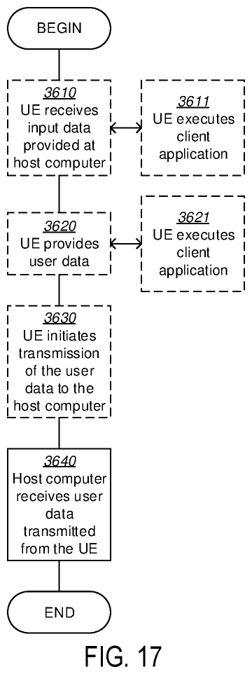

FIG. 17 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 17 will be included in this section. In step 3610 (which may be optional), the UE receives input data provided by the host computer. Additionally or alternatively, in step 3620, the UE provides user data. In substep 3621 (which may be optional) of step 3620, the UE provides the user data by executing a client application. In substep 3611 (which may be optional) of step 3610, the UE executes a client application which provides the user data in reaction to the received input data provided by the host computer. In providing the user data, the executed client application may further consider user input received from the user. Regardless of the specific manner in which the user data was provided, the UE initiates, in substep 3630 (which may be optional), transmission of the user data to the host computer. In step 3640 of the method, the host computer receives the user data transmitted from the UE, in accordance with the teachings of the embodiments described throughout this disclosure.

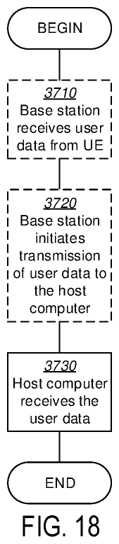

FIG. 18 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 18 will be included in this section. In step 3710 (which may be optional), in accordance with the teachings of the embodiments described throughout this disclosure, the base station receives user data from the UE. In step 3720 (which may be optional), the base station initiates transmission of the received user data to the host computer. In step 3730 (which may be optional), the host computer receives the user data carried in the transmission initiated by the base station.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one skilled in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/ or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A method in a terminal device comprising:
receiving, from a network node, a configured grant that indicates resources occupying at least a guard band; and
performing an uplink transmission to the network node using at least the guard band.

2. The method according to claim 1, wherein the resources indicated by the configured grant further occupy a subband adjacent to the guard band and wherein the uplink transmission is performed using the guard band and the subband adjacent to the guard band.

3. The method according to claim 1, wherein a location and a size of the guard band is signaled from the network node.

4. The method according to claim 1, wherein a location and a size of the guard band is preconfigured.

5. The method according to claim 1, wherein the configured grant is received in a configured grant configuration and wherein the configured grant configuration indicates that the resources indicated by the configured grant are overlapped with the guard band.

6. The method according to claim 1, wherein the configured grant is received in a configured grant configuration and wherein the configured grant configuration indicates that the resources indicated by the configured grant are within the guard band.

7. The method according to claim 1, further comprising performing listen before talk (LBT) operations for subbands associated with the guard band, wherein the uplink transmission is performed based on results of the LBT operations.

8. The method according to claim 7, wherein the LBT operations are performed for two subbands adjacent to the guard band and wherein the uplink transmission is performed when the results of the LBT operations indicate that the two subbands are available for the terminal device.

9. The method according to claim 1, wherein subbands associated with the guard band are indicated by the network node as available for channel occupancy time (COT) sharing, wherein part of a downlink COT is able to be shared with configured grant based transmissions and wherein a location and a size of the guard band is indicated by the network node as available for an uplink transmission.

10. The method according to claim 9, wherein the subbands and the location and the size of the guard band are indicated by the network node in one or more of:
COT structure information signaling;
radio resource control (RRC) signaling;
media access control (MAC) control element (CE); and
downlink control information (DCI).

11. The method according to claim 1, wherein performing the uplink transmission using at least the guard band comprises:
mapping first, at least one code block group (CBG) to physical resource blocks (PRBs) occupying the guard band, the first, at least one CBG being different from second, at least one CBG mapped to PRBs not occupying the guard band; or
mapping first, at least one logical channel to PRBs occupying the guard band, the first, at least one logical channel having lower priority than second, at least one logical channel mapped to PRBs not occupying the guard band.

12. The method according to claim 1, further comprising transmitting, to the network node, an indication about the uplink transmission using at least the guard band.

13. The method according to claim 12, wherein the indication about the uplink transmission comprises a first indicator indicating whether there is an uplink transmission in a guard band.

14. The method according to claim 13, wherein the first indicator for a subband comprises two bits indicating whether there is an uplink transmission in an upper guard band and a lower guard band of the subband respectively.

15. The method according to claim 13, wherein the indication about the uplink transmission further comprises a second indicator indicating a location and a size of the guard band.

16. The method according to claim 12, wherein the indication about the uplink transmission is transmitted to the network node in uplink control information (UCI).

17. The method according to claim 1, further comprising determining whether to enable the use of a guard band for an uplink transmission, based on current channel occupancy or LBT failure statistics measured by the terminal device.

18. A method in a network node comprising:
transmitting, to a terminal device, a first configured grant that indicates resources occupying at least a first guard band; and
receiving an uplink transmission from the terminal device in at least the first guard band.

19. The method according to claim 18, wherein the resources indicated by the first configured grant further occupy a first subband adjacent to the first guard band and wherein the uplink transmission is received in the first guard band and the first subband.

20-31. (canceled)

32. A terminal device comprising:
at least one processor; and
at least one memory, the at least one memory containing instructions which, when executed by the at least one processor, cause the terminal device to:
receive, from a network node, a configured grant that indicates resources occupying at least a guard band; and
perform an uplink transmission to the network node using at least the guard band.

33-38. (canceled)
